(19) United States
(12) Patent Application Publication
(10) Pub. No.: US 2004/0207893 A1
(43) Pub. Date: Oct. 21, 2004

(54) Channel processing unit for WDM network

(76) Inventors: Samuel Lee Miller, Albuquerque, NM (US); Michael Hodges, Palo Alto, CA (US); Paul Jackson McWhorter, Albuquerque, NM (US)

Correspondence Address: Kent A. Fischmann, Esq., Suite 411, 3151 South Vaughn Way, Aurora, CO, 80014, US

(21) Appl. No.: 10/097,296

(22) Filed: Mar. 14, 2002

(51) Int. Cl. G02B 6/28; H04J 14/02

(52) U.S. Cl. 359/212; 385/24

(57) ABSTRACT

A novel optical channel processing unit is disclosed that is useful for multiplexing, demultiplexing, switching and otherwise processing optical signals in a WDM network. In one embodiment, the optical channel processing unit is implemented as an optical switch (700) for interfacing any of various multichannel input ports (702) with any of various multichannel output ports (704). The illustrated switch (700) includes a two-dimensional array of input ports (702) and a two-dimensional array of output ports (704). An input signal (705) is transmitted via a spectral device (706) to an input movable mirror array (708). A signal transmitted by an output port (704) is transmitted via a spectral device (712) to mirrors (714) of an output mirror movable mirror array (716). Each mirror of each array (708 and 716) is movable to target any selected mirror of the opposing array (708 or 716). The arrays (708 and 716) thereby support full multichannel switching functionality for more than two channels. The optical channel processing unit may also allow for adding, dropping and processing single or multiple channel signals.

### FIELD OF THE INVENTION

The present invention relates generally to optical communications networks including Wavelength Division Multiplexed or Dense Wavelength Division Multiplexed communications networks (collectively, “WDM networks”) and, in particular, to optical channel processing units for processing, such as multiplexing, demultiplexing and/or switching optical signals including signals of various channels in a WDM network, especially processing optical signals using movable mirrors and MEMS structures.

### BACKGROUND OF THE INVENTION

Voice, video and data communications are increasingly supported by WDM networks. In WDM networks, individual optical fibers are lighted with signals of multiple (two or more) carrier wavelengths or channels, thereby increasing the capacity or bandwidth supported by the fiber. The principal advantage of WDM networks is the ability to increase network capacity for a given amount of fiber. This reduces network costs, forestalls disruptive network construction projects, and reduces network size.

There are a number of functions that are generally addressed to ensure proper administration of a WDM network. First, there is generally some mechanism for inserting multiple channel signals into a single fiber. This is termed multiplexing. Conversely, there is generally some mechanism for separating the individual channels from a multiplexed signal, for example, for processing by single wavelength components. This is termed demultiplexing. Additionally, there is generally some mechanism for individually routing the various channel signals through the network. This may be accomplished by switches. Other functions include adding or dropping signals relative to a section of optical network under consideration, manipulating the timing of optical signals such as by selectively introducing delays in individual or multiple channels, managing the relative strengths (“balancing”) of the various channel components of a WDM signal, etc.

Various mechanisms are available for multiplexing. For example, fiber pigtails may be used to couple multiple channels into a single WDM fiber. Alternatively, multiple sources, input fibers, or other input ports for transmitting multiple channel signals may be coupled to a WDM fiber end via lenses, diffraction gratings or other optics. In any case, such mechanisms are generally dedicated to a particular WDM fiber or otherwise involve a high degree of component replication in relation to a large WDM fiber bundle and/or have limited flexibility for coupling multiple input ports to the various WDM fibers of an output bundle.

Demultiplexing can also be accomplished by various mechanisms. For example, a WDM fiber or other input port may be coupled to multiple output fibers, receivers or other output ports via a diffraction grating or other wavelength separator and associated optics for mapping signals from the WDM fiber to the output ports on a wavelength dependent basis. Again, such mechanisms are generally dedicated to a particular WDM fiber or otherwise involve a high degree of component replication in relation to a large WDM fiber bundle and/or have limited flexibility for coupling multiple WDM fibers of a fiber bundle to multiple output ports.

Switching relates to the process by which signals are routed through a network from a transmitting node to a receiving node. It will be appreciated that many communications are bi-directional in nature and, accordingly, references to “transmitting” and “receiving” as well as “input” and “output” ports and the like herein are largely a matter of semantic convenience. In any event, WDM networks generally need to accommodate individual routing of the various channel signals as well as various combinations of channel signals in a single WDM fiber at different times or in successive WDM fibers within the network. Significant switching flexibility is therefore desired.

Such switching is often performed by optical-electrical-optical (OEO) switches. In such switches, the incoming optical signal is converted into an electrical signal, switching is performed in the electrical domain, and the outgoing signal is converted back into the optical domain. OEO switches allow for use of well developed electrical switch technology within the optical portion of the network. However, OEO switches are increasingly becoming the bandwidth bottlenecks of modern communication networks. In addition, such switches generally entail reading routing information from packet headers and the like, and are therefore protocol dependent.

Significant effort has therefore been directed to developing optical cross connect (OXC) switches for various network applications. OXC switches perform at least some switching functionality by directing signals in the form of beams between input and output ports without converting the signals into another domain. Such switches can therefore be substantially transparent to the transmitted signals, thereby enhancing bandwidth capabilities and avoiding compatibility issues in connection with new or varying network communication protocols.

Generally, however, proposed OXC switches have not fully addressed issues relating to channel processing, e.g., how to separately route and variably combine signals of different channels. Thus the switching functionality has generally had to be performed separately for each channel. Specifically, an incoming WDM signal is generally demultiplexed into its channel components, switching is separately implemented for each channel component using hardware dedicated to that component at least during that switching time interval, and the switched channel signals are then multiplexed for transmission through the next leg of the network. In some cases it has been proposed to perform the multiplexing and demultiplexing functions within the free space switch interface upstream and downstream from the switching components for a limited number of wavelength channels. In other cases, the multiplexing and demultiplexing is conducted outside of the free space switch interface. In either case, switching has generally been separately implemented for each channel, resulting in substantial component or component support replication, limited channel management capabilities and/or limited flexibility in switch design. Moreover, proposed channel processing units have generally not addressed various additional functionality such as dropping and adding signals and balancing the channels of a WDM signal.

### SUMMARY OF THE INVENTION

The present invention is directed to an optical channel processing unit useful for, inter alia, multiplexing, demultiplexing, dropping, adding, balancing and switching optical signals, especially in a WDM network. The channel processing unit can support such functions using individual channel combiners/separators and mirror arrays to service multiple fibers or other ports and multiple channels, thereby potentially reducing the required structure and dimensions of the associated interface. Moreover, in the switching context, the channel processing unit allows for separation of multiple channels from WDM signals of multiple input fibers, selective regrouping of the channel signals to form a set of new single channel or WDM signals, and mapping of single channel or WDM signals to the fibers of an output array, all within the confines of a single free space box using a minimum of mirror arrays. The invention thus facilitates the implementation of OXC switches in WDM networks without undue replication of structure for each channel.

According to one aspect of the present invention, an optical channel processing unit is provided that supports multiplexing, demultiplexing and switching functionality. The apparatus includes: at least one port for transmitting or receiving a multichannel signal; an array of movable mirrors for redirecting optical signals; and a spectral processing device optically interposed between the mirror array and the port(s) for dividing the multichannel signal into individual channel components and/or combining multiple components into an output multichannel signal. The port(s) may include an input port such as an optical fiber, optical detector, mirror, lens or the like for use in receiving a multichannel signal. The spectral processing device can include one or more prisms, diffraction gratings or other devices for converting between a multichannel signal and signal components on separate pathways. The mirror array comprises an arrangement of mirrors where each mirror is adapted for coupling to a port via the spectral processing device. In certain embodiments, the mirrors are mounted on a common support structure and individually or collectively redirect signals of multiple channels. Preferably, the mirrors are arranged in a two-dimensional array, the array has a substantially planar configuration and the array is fabricated on one or more substrates. Such substrates are preferably structures that can be handled by the types of equipment and processes that are used to fabricate micro-devices on, within, and/or from the substrate using one or more micro photolighographic patterns or similar batch fabrication equipment and processes. In this regard, the “mirrors” may include any appropriate positionable reflective microstructures. For certain applications, the mirrors are movable with one degree of freedom and, for other applications, with at least two degrees of freedom for targeting relative to two dimensions.

For demultiplexing applications, a port is operated to transmit a multichannel signal which is separated into its channel components and directed to the mirror array by the spectral processing device. The individual mirrors can then be operated to direct the channel signals on desired output paths, e.g., to detectors or other output ports. In a preferred embodiment, the mirror array is used in conjunction with a second mirror array to direct output signals to an array of fibers or other ports. Such a dual array embodiment allows for increased optical density of the signals at the output port and allows for outputting single or multichannel signals. In the latter regard, a spectral device or other optics may be used to combine separate channel components from separate mirrors into a multichannel signal. The demultiplexer thereby also functions as a 1×N switch or, more precisely, a 1×N×M switch where such nomenclature denotes a switch having one input port, N output ports and being capable of handling M channels, where M and N are integers greater than one and may be the same or different. For cases where the output fibers receive single channel signals, such a switch can be operated bi-directionally with substantially full signal retention.

For multiplexing applications, the mirror array receives a number of signals to be multiplexed and directs at least two of the input signals to a port, e.g., an output fiber, via the spectral processing device. In one embodiment, the input signals are received from multiple input fibers or other ports via a second array of movable mirrors. In this manner, the mirrors of the second array can be used to direct individual channel signals from any of the input fibers to a mirror of the first mirror array that is configured to direct that channel to the port. The optical channel processing unit can thereby function as an N×1×M switch. Such a switch may be operated bi-directionally.

A high volume multiplexer/demultiplexer can be achieved by associating multiple ports with the spectral processing device. Specifically, the associated optical channel processing unit includes multiple ports optically interfaced with a first array of movable mirrors via a spectral processing device. In the demultiplexing mode, one or more of the ports transmits a multichannel signal that is divided into individual channel components by the spectral processing unit. In the multiplexing mode, the first mirror array receives multiple input channel signals and directs at least two channel signals to one of the ports via the spectral processing device. The first mirror array can be interfaced with an array of second ports via a second array of movable mirrors such that any of the first ports can be optically coupled with any of the second ports for bi-directional signal communication therebetween. The resulting optical channel processing unit thereby defines an M×N×L switch where M, N and L are integers greater than one and may be the same or different. It will be appreciated, however, that such a switch may entail certain limitations relative to bi-directional communication of multi-channel signals.

A further advantageous OXC switch may be achieved by disposing optical channel processing units as described above in a back-to-back relationship. Such a switch includes a first set of ports optically interfaced with a first array of movable mirrors via a spectral processing device, and a second set of ports optically interfaced with a second array of movable mirrors via a second spectral processing unit, where the first and second arrays are configured for selectable optical coupling therebetween. In a preferred implementation, each of the spectral processing devices is operative for redirecting signal components on a channel dependent basis such that each mirror of each array can be spatially addressed to a single channel of a single fiber. Additionally, the arrays are preferably two-dimensional mirror arrays where each mirror of each array is movable to redirect input signals from an associated input port to mirrors of the opposing array associated with any of the output ports (or any of such mirrors associated with the same channel) and to redirect output signals from any mirror of the opposing array to the associated output port.

The resulting N×M×L switch is fully functional in bi-directional operation for separating multiple input WDM signals into their channel components, arbitrarily (variably under direction of a control system) combining channel components from the input WDM signals to form new WDM signals, and outputting such signals via selected output ports. Additional fixed mirrors or movable mirror arrays may be optically interposed between the first and second arrays and/or between either of the arrays and its associated ports, e.g., for optical folding to fit the switch within a desired spatial envelope or to lengthen the optical path length between the arrays (thereby reducing the required range of angular motion of the mirrors), for improved optical symmetry and associated optical density area at the output ports, or for decoupling the pitch or cross-sectional area (relative to an optical axis) of the mirror arrays from the pitch of the port structure. If such switch configurations are capable of outputting two signal components of the same channel to the same output port, the switch control system may be programmed to avoid such combinations if desired.

It will be appreciated that such an optical switch, constructed in accordance with the present invention, differs in many important respects from proposed switches that employ separate dedicated movable mirror arrays for switching signals of each channel. In this regard, it is noted that the spatial envelope, defined by the set of possible pathways for traversing the switch interface from the input ports to the output ports, for each channel may overlap that for other channels. That is, the switch need not provide fully separate spatial switch interface regions for each channel. Moreover, the number of arrays is independent of the number of channels. For example, only two arrays may support more than two channels. Additionally, switch architectures in accordance with the present invention support two-dimensional port arrangements, e.g., fiber bundling, without undue proliferation of array structures. The invention potentially enables reduction of switch size and cost, enhancement of switch functionality and improved flexibility in switch design.

In accordance with another aspect of the present invention, at least one additional port is provided at an optical interface, e.g., associated with a multiplexer, demultiplexer or switch, to allow for a multifunction optical processing unit. The associated optical apparatus includes an optical interface between a first portion of a network and a second portion of a network where optical signals are communicated between the first and second portions of the network via the interface; at least one first optical port at the interface associated with the first portion of the network; at least one second optical port at the interface associated with the second portion of the network; at least one additional port at the interface; and optics including at least one movable mirror for establishing an optical connection between the additional port and at least one of the first and second ports such that, upon establishing the connection, a difference is established between first optical signals of the first portion of the network and second optical signals of the second portion of the network. The at least one additional port may include an add port for adding a signal and/or a drop port for dropping a signal.

In one implementation, multiple auxiliary ports are provided in connection with a multifunction optical channel processing unit or superswitch. The superswitch thus includes a number of input ports, preferably capable of transmitting and receiving multichannel signals, a number of output ports, preferably capable of transmitting and receiving multichannel signals, one or more arrays of movable mirrors for switching optical signals between the input ports and output ports, and one or more spectral devices for enabling switching of optical signals on a wavelength dependent basis as discussed above. The superswitch further includes a number of auxiliary ports. These auxiliary ports preferably include one or more add ports for adding optical signals and one or more ports for dropping optical signals. Additionally, the auxiliary port may include one or more pairs of ports that are interconnected via a signal processing module. For example, the signal processing module may include a wavelength shifter for changing the wavelength of a signal, a delay circuit for delaying a signal or various other types of processing modules. In this manner, the superswitch can serve multiple functions including multiplexing, demultiplexing, switching (including on a wavelength dependent basis), adding signals, dropping signals, amplifying signals, attenuating signals, delaying signals and other functions, all in connection with one or more free space interface units.

In accordance with a further aspect of the present invention, a channel balancer is provided for use in connection with a WDM processing unit. The WDM processing unit may be, for example, a multiplexer or a multiple wavelength switch. An associated optical apparatus includes: a number of first optical ports; at least one second optical port; movable mirrors for selectively redirecting optical signals transmitted between the first and second optical ports, wherein the second optical port receives a WDM signal including a first component of a first wavelength and a second component of a second wavelength; and a balancer operative on at least one of the first and second components between the first and second ports such that the relative strengths of the first and second components of the WDM signal at least more closely approach a desired relationship. In many cases, it will be desired that the various components of a WDM signal have substantially equal strengths. In this manner, the signal components can be kept within the preferred dynamic range of various network components.

The balancer can achieve the desired relationship between the various signal components by selectively amplifying or attenuating one or more of the signal components. In certain embodiments, wavelength components are selectively attenuated. For example, selected components can be attenuated by operating one or more of the movable mirrors so as to alter the alignment of an optical path of one of the components relative to the second port so as to attenuate that component. Alternatively, a deployable element such as a shutter may be extended into an optical path of a component to controllably attenuate that component. In either case, such attenuation may be implemented in response to the output from one or more sensors. Such sensors are used to measure the strength of one or more of the components. The sensor can measure such strength within the interface or outside of the interface. In one embodiment, such a balancing system is implemented in connection with a WDM switch so as to allow for balancing of the signal components as received at each of the input and output ports.

### BRIEF DESCRIPTION OF THE DRAWINGS

For a more complete understanding of the present invention and further advantages thereof, reference is now made to the following Detailed Description taken in conjunction with the drawings, in which:

FIG. 1 illustrates a demultiplexer in accordance with the present invention;

FIG. 2 illustrates a multiplexer in accordance with the present invention;

FIG. 3 illustrates a high volume demultiplexer or multiplexer in accordance with the present invention;

FIG. 4 illustrates the use of a high volume demultiplexer and a high volume multiplexer in a back-to-back relationship to provide a WDM optical switch with multichannel ports;

FIG. 5 illustrates the use of a high volume multiplexer and a high volume demultiplexer in a back-to-back relationship to provide a WDM switch with single channel ports;

FIG. 6 illustrates an alternative embodiment of a multichannel optical switch in accordance with the present invention;

FIG. 7 illustrates a multichannel switch with reduced components in accordance with the present invention;

FIG. 8 illustrates a multichannel switch employing a folding mirror in accordance with the present invention;

FIG. 9 illustrates a multichannel optical switch utilizing a folding mirror and minimal components in accordance with the present invention;

FIG. 10 illustrates a further alternative embodiment of a multichannel optical cross connect switch in accordance with the present invention;

FIG. 11 illustrates a multifunction optical channel processing unit in accordance with the present invention;

FIG. 12 is a schematic diagram of a signal balancing system in accordance with the present invention;

FIG. 13 is a schematic diagram illustrating various possible sensor implementations for a channel balancing system in accordance with the present invention;

FIG. 14 illustrates one system for attenuating signal components in accordance with the present invention;

FIG. 15 illustrates another system for attenuating signal components in accordance with the present invention; and

FIG. 16 illustrates a further system for attenuating signal components in accordance with the present invention.

### DETAILED DESCRIPTION

The present invention is directed to an optical channel processing unit for use in manipulating single and multichannel signals in a WDM network. The invention is useful in connection with any of various processing operations that involve combining, separating, routing and intermixing channel signals or components. The following discussion sets forth the invention in the context of various embodiments and implementations for multiplexing, demultiplexing, switching and other processing involving at least one multichannel signal. Upon consideration of the following discussion, it will be appreciated that other embodiments, implementations and applications of the optical channel processing unit are possible in accordance with the present invention.

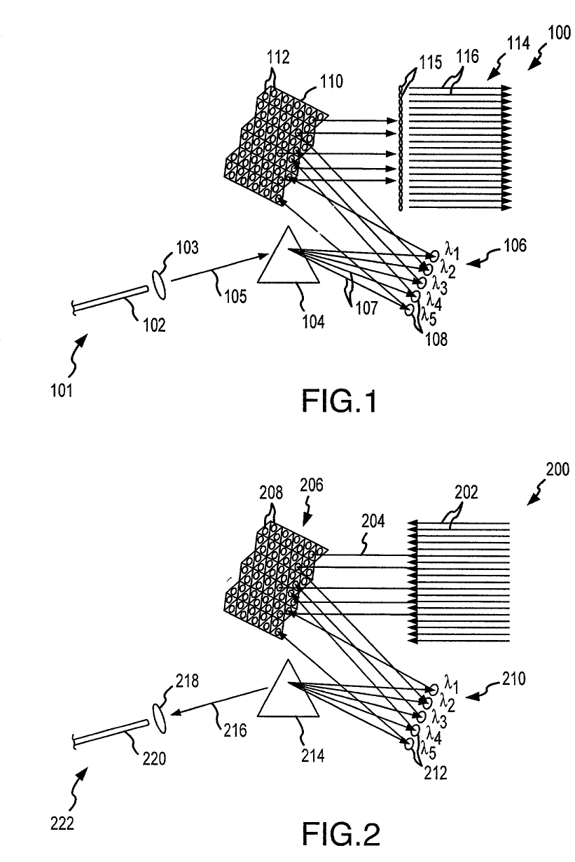

FIG. 1 illustrates an optical demultiplexer 100 in accordance with the present invention. The demultiplexer 100 generally includes an input fiber 101, a channel separator 104, a first mirror array 108, a second mirror array 110, and a set 114 of output fibers 116. The input port 101 transmits a multichannel signal 105. The multichannel signal 105 includes at least two channel components and, in practical embodiments, may include many different channel/wavelength components. These channel components are transmitted on a common optical pathway, e.g., in a single multichannel optical beam, and constitute a WDM signal.

The demultiplexer 100 may be used in a variety of applications. For example, it may be desired to demultiplex a multichannel signal in the context of a spectrometer. In particular, a multichannel signal under analysis may be divided into multiple channel components and each of those channel components may be directed to a separate detector so as to provide an indication of the spectral composition of the input signal. In addition, such a demultiplexer may be used in connection with various types of instruments for analyzing the composition of a fluid or other material based on analysis of wavelength dependent radiation attenuation characteristics. In such cases, a multichannel signal transmitted through the material may be separated into components that are directed to separate detectors used to analyze wavelength or wavelength ranges of interest. Optical demultiplexers are also useful in connection with WDM communications networks. In particular, a WDM signal may be demultiplexed for handling by various single wavelength optical components or for separately routing the individual channel signals. It will be appreciated that there are many other possible applications of the illustrated optical demultiplexer 100.

The input port 101 may be any component for transmitting the multichannel signal 105. Examples include a multichannel source, a mirror or a prism. In the illustrated embodiment, the input port includes an optical fiber 102 and optics 103 for forming the signal transmitted from the fiber 102 into a beam. The optics 103 may be, for example, a collimator, a lens or lenses. In the illustrated embodiment, the optics 103 include a lens configured to collimate or focus the signal 105. For example, in the case of a focusing lens, the signal 105 may be focused on optics associated with an output port.

The multichannel signal 105 is transmitted to a channel separator 104 that separates the multichannel signal 105 into its channel components 107. These channel components 107 are separately directed for handling by the individual mirrors 108 of the first mirror array 106. A variety of different optical components may be used for this separating and redirecting process. For example, the channel separator 104 may include one or more diffraction gratings or prisms. Preferably, the separator 104 spatially distributes the resulting channel signals on a wavelength dependent basis and in a known manner. To facilitate understanding, the separator 104 is schematically illustrated as a prism.

The channel signals 107 emanating from the channel separator 104 in the illustrated embodiment are spatially separated on a wavelength dependent basis. Five separate channels are illustrated in this regard. These channel signals 107 are received by the individual mirrors 108 of the mirror array 106. The illustrated array 106 is a linear array corresponding to the fan array of the channel signals 107 from the channel separator 104. It will be appreciated that different patterns of the channel signals 107 and the mirror array 106 may be provided, depending on the nature of the channel separator 104. Each of the mirrors 108 of array 106 is movable to redirect the channel signals 107 to a selected mirror 112 of the second array 110. In the illustrated unit 100, the mirrors 108 are movable in two degrees of freedom to target any mirror 112 of the two-dimensional array 110. Preferred embodiments for the movable mirrors shown in this and the following embodiments are set forth in U.S. patent application Ser. No. 09/966,963 entitled “Large Tilt Angle MEM Platform,” filed on Sep. 27, 2001, which application is incorporated herein by reference. Such movable mirrors elevate in addition to rotating relative to reference axes. This is advantageous in that high tilt angles can be achieved, as may be desired. In addition, different effective packing densities may be achieved by changing the orientation of the array 106 relative to the incoming optical signal pathways. In this manner, effective packing densities up to 100% can be achieved, for example, relative to an axis orthogonal to an axis of the incident signal pathways. The orientation of the array 106 can also be selected such that the mirror spacing is appropriate for a particular channel separator 104 and separator/array geometry. More generally, the ability to achieve different packing densities using a given array design is useful from a manufacturability/cost perspective. The movable mirrors 112 of the second mirror array 110 are operative for receiving the channel signals from the first array 106 and redirecting the channel signals to the output ports 114. In the illustrated embodiment, the output ports 114 are a number of optical fibers 116 arranged in a two-dimensional bundle together with associated lenses or other optics 115 for inserting the output signals into the fibers 116. In order to optimize signal insertion into the fibers 116, the mirrors 112 of array 110 are preferably axially aligned relative to the fibers 116. Thus, each of the mirrors 112 is associated with one of the fibers 116. The orientation of the array 110 may be selected so that the packing density of the mirrors 112 substantially matches that of the fibers 116. Accordingly, the mirrors 108 of the first array 106 are positioned to target a particular mirror 112 of the second array 110, depending on the desired output fiber 116 for that channel component.

The illustrated demultiplexer 100 is thus operative for separating the input signal 105 into its various channel components 107 and directing each one of those channel components 107 into a selected one of the output fibers 116. Any one of the channel components 107 may be directed into any one of the fibers 116. Moreover, the demultiplexer 100 may be reconfigured so that a given output fiber 116 will receive different channel signals at different times. In this regard, it will be appreciated that the demultiplexer 100 can function unidirectionally as a 1×N×M switch. Moreover, as will be appreciated from the following discussion, such a switch can operated bi-directionally as a 1×N×M switch for interfacing a multichannel port with multiple single channel ports.

FIG. 2 illustrates a multiplexer 200 in accordance with the present invention. The construction of the multiplexer 200 may be identical to the demultiplexer described above and, for purposes of brevity, such description will not be repeated. Operationally, the multiplexer 200 is operative for combining a number of single channel input signals 204 into a single multichannel output signal 216. Specifically, each of the input fibers 202 transmits a single channel signal 204 to an aligned mirror 208 of the first array 206. The mirror 208 is positioned to redirect the input signal 204 to the mirror 212 of array 210 associated with that channel. The mirror 212, in turn, is positioned to direct the channel signal 204 to a position relative to the channel combiner 214 associated with the location of the output port 222, in this case, an optical fiber 220 and associated insertion optics 218. The channel combiner 214 may be identical to the channel separator described above operated in the reverse direction, i.e., in a reverse polarity.

In the illustrated embodiment, up to five different channels, each originating from any of the fibers 202, can be combined in the single output fiber 220. It will be appreciated that the illustrated multiplexer 200 is optically symmetrical relative to bi-directional communications. That is, for given positions of the mirrors of the arrays 206 and 210, signals can be bi-directionally communicated from the input fibers 202 to the output fiber 220. Moreover, the specific fibers 202 to be interfaced with fiber 220 can be selected based on the mirror configurations. Accordingly, the multiplexer 200 can function as a switch for selectively interfacing a number of fibers 200 up to the number of channels supported by the mirror arrays, with the fiber 220. Such a 1×N×M switch may be modified for N×M×L switching applications, as will be understood from the description below.

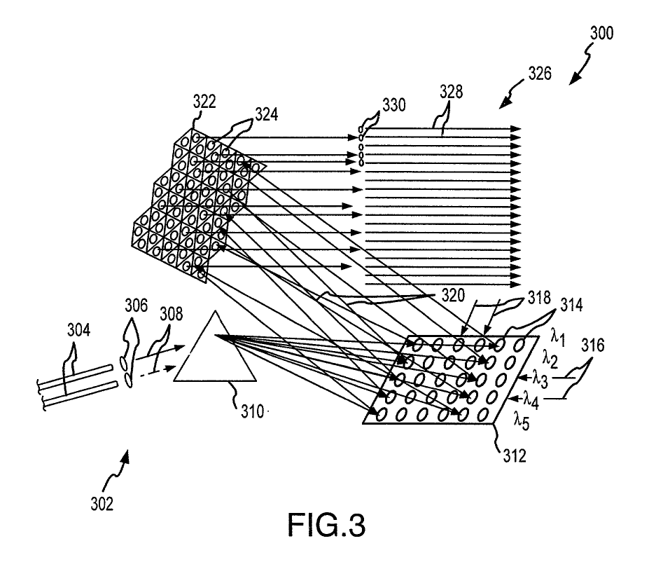

FIG. 3 illustrates a high volume multiplexer/demultiplexer unit 300. The unit 300 generally includes a number of input ports 302, a spectral device 310, a first array 312, a second array 322 and a number of output ports 326. The unit 300 is operative for multiplexing two or more single channel signals 320 from associated ports 326 into a multichannel signal 308 at a selected one of the ports 302, for demultiplexing a multichannel signal 308 from any one of the ports 302 into multiple single channel signals 320 for receipt at corresponding ones of the ports 326, and/or for bi-directional communication of signals between single channel ports 326 and multichannel ports 302.

The first ports 302 are operative for transmitting and/or receiving multichannel signals 308. In this regard, one or more of the ports 302 may receive a multichannel signal and other ones of the first ports 302 may receive single channel signals at a given time. In the illustrated embodiment, the first ports 302 include optical fibers 304 and associated optics 306. In the transmit mode, the ports 302 transmit one or more multichannel signals 308 to the spectral device 310 that separates the signal 308 into its channel components. These channel components are directed to the mirrors 314 of mirror array 312. The device 310 outputs the channel signals 320 on pathways that are dependent on channel as well as the identity of the input port 302. In this regard, the mirror array 312 has a first dimension that relates to the number of channels and a second dimension that relates to the number of first ports 302. More particularly, each of the columns 316 of the illustrated array 312 corresponds to a particular channel and each of the rows 318 of array 312 corresponds to a particular port 302. Thus, the illustrated array 312 supports six ports 302 and five channels per port. It will be appreciated that different numbers of channels and ports, including substantially larger numbers of channels and ports, may be supported in accordance with the present invention. Moreover, as will be understood from the description below, the rows and columns of an array need not be uniquely associated with particular channels and ports.

Each of the mirrors 314 of the array 312 is operative to redirect the associated channel signal 320 to a selected mirror 324 of the second array 322 that is associated with a desired one of the output ports 326. In the illustrated embodiment, each of the output ports 326 includes an optical fiber 328 and associated optics 330. For improved optical efficiency, each one of the mirrors 324 of the array 322 is preferably axially aligned with an associated one of the fibers 328.

In the reverse mode, a single channel signal transmitted from one of the fibers 328 is received by a corresponding one of the mirrors 324 of the array 322. The mirror 324 redirects the signal to a mirror 314 of the first array 312 that is associated with the desired port and channel. This mirror 314 redirects the signal 320 along a pathway to the spectral device 310 selected to allow receipt of the signal 320 at the desired port 302, in the illustrated case, insertion into the selected fiber.

It will thus be observed that the unit 300, in addition to functioning as a high volume demultiplexer or multiplexer, is operative as an N×M×L switch. In particular, the unit 300 can interface any of multiple single channel input ports 326 with any of multiple multichannel ports 302. However, it may be desired to provide a multichannel switch for interfacing a first set of multichannel ports with a second set of multichannel ports. This can also be accommodated in accordance with the present invention, as set forth below.

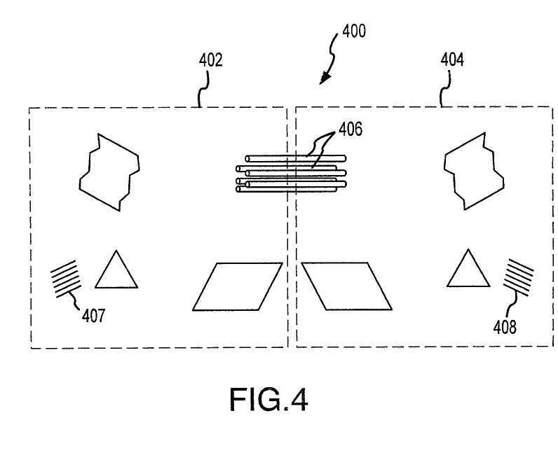

FIG. 4 illustrates a multichannel optical switch 400 in accordance with the present invention. The switch 400 includes a first unit 402 and a second unit 404 arranged in a back-to-back relationship. Each of the units 402 and 404 may be identical in construction to the high volume demultiplexer/multiplexer unit described above in connection with FIG. 3. For purposes of brevity, the description of the individual components thereof will not be repeated. From the description above, it will be readily appreciated that unit 402 is operative for interfacing any of multiple multichannel input ports 404 with any of multiple single channel ports 406. Similarly, unit 404 is operative for interfacing any of multiple single input ports 406 with any of multiple input ports 408. The result is a fully functionally N×M×L switch for interfacing a first set of multichannel ports 404 with a second set of multichannel ports 408. Although more simple embodiments of such a switch will be described below, the illustrated switch 400 may be desirable in a number of contexts. In particular, because the switch 400 employs identical (or mirror image) units 402 and 404, ease of construction is facilitated. Moreover, because the two units 402 and 404 can be linked by flexible optical fibers 406, the switch 400 may be folded to accommodate various restraints on switch configuration or size. Also, by providing one or more wavelength translators between units 402 and 404, greater flexibility can be achieved in intermixing channel components from the various ports.

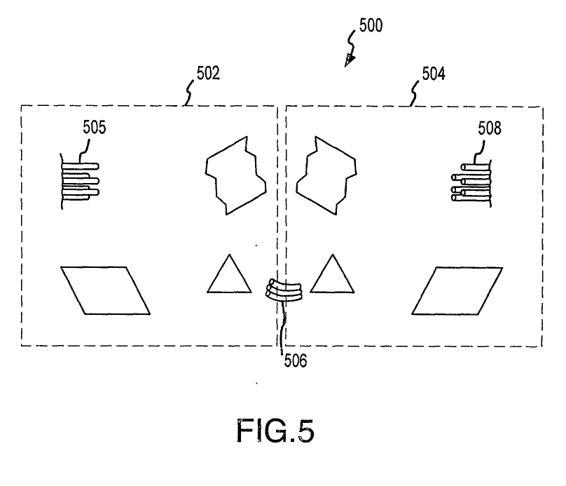

FIG. 5 illustrates a modification to interface a set of single channel input ports with a set of single channel output ports where the ports collectively handle signals of multiple channels. The illustrated switch 500 includes units 502 and 504 which, again, may be identical in construction to the high speed multiplexer/demultiplexer described in connection with FIG. 3. This time, however, unit 502 is operative for interfacing multiple single input ports 505 with multiple multichannel ports 506. Unit 504 is operative for interfacing multiple multichannel ports 506 with multiple single channel ports 508. The switch 500 thus interfaces single channel ports 505 with single channel ports 508 using multichannel arrays and a potentially reduced set of multichannel connecting fibers 506. Such an embodiment may be desirable for switching, as between multiple single channel fibers, in order to fabricate mirrors used for switching each channel on a single fabric and to minimize the number of connecting fibers.

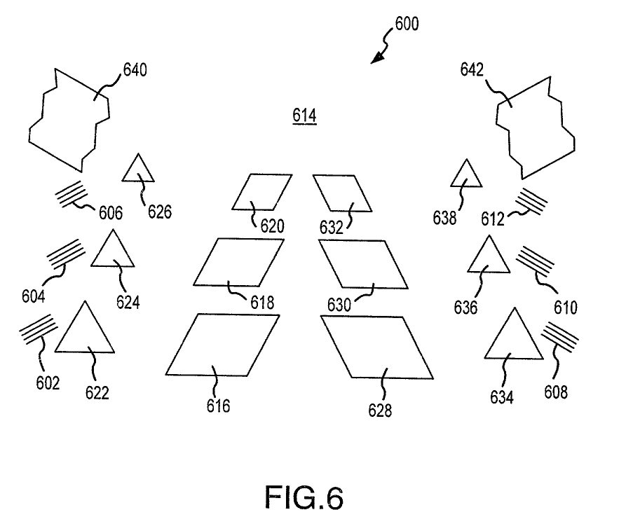

Although switches as described above including intermediate fiber segments may be desirable for certain applications, in other applications it may be desirable to implement the full switching functionality within a single free space box. A number of embodiments for achieving this are described below. Referring briefly again to the embodiment of FIG. 4, it may be observed that the intermediate fibers 406 could be removed to allow for direct optical interfacing of the various mirror arrays within a single free space box. A related embodiment is shown in FIG. 6. In particular, the switch 600 of FIG. 6 includes a number of input port arrays 602, 604 and 606 interfaced with a number of output port arrays 608, 610 and 612 across a free space switch interface 614. Input ports 602, 604 and 606 are interfaced with input movable mirror arrays 616, 618 and 620, respectively, via respective spectral devices 622, 624 and 626. Similarly, output port arrays 608, 610 and 612 are interfaced with output movable mirror arrays 628, 630 and 632, respectively, by respective spectral devices 634, 636 and 638. The mirrors of each of the input arrays 616, 618 and 620 are movable to direct signals between the input ports 602, 604 and 606 on the one hand and the mirrors of second input array 640 on the other. The mirrors of each of the output arrays 628, 630 and 632 are movable to redirect beams between the output port arrays 608, 610 and 612 on the one hand and the mirrors of second output array 642 on the other hand. The mirrors of array 640 are movable to target the mirrors of array 642 and vice versa.

In operation, each of the ports of the arrays 602, 604, 606, 608, 610 and 612 is operative for transmitting and receiving multichannel signals. Each of the spectral devices 622, 624, 626, 634, 636 and 638 is operative for dividing multichannel signals into their channel components and for combining individual channel signals into multichannel signals. Thus, a multichannel signal transmitted from an input port, for example, of array 602 is divided into its channel components by device 622. The channel components are then reflected by the corresponding mirrors of array 616 to one or more mirrors of array 640 and, from there, to one or more mirrors of array 642. The channel components are then directed to mirrors of array 628, 630 and/or 632, depending on channel and the desired output port. The process is reversed for signals transmitted from an output port to an input port.

The illustrated switch 600 thus provides a fully functional M×N×L switch for interfacing multichannel input ports with multichannel output ports. Input multichannel signals are divided into their channel components which are separately routed through the switch and recombined to form new multichannel signals that are directed to desired output fibers, all within a single free space box. The illustrated embodiment has a number of advantages. First, it will be observed that the various input port arrays, spectral devices and input/output arrays form a number of substantially identical (or mirror image) units that can be easily constructed on a large scale. It will be appreciated that more than one optical pathway is possible to connect a given mirror of input arrays 616, 618 and 620 with a given mirror of output arrays 628, 630 and 632. Accordingly, in certain circumstances, a reduced number of mirrors may be utilized in the arrays 640 and 642. Additionally, any malfunctioning mirror of arrays 640 and 642 can be avoided and spare mirrors may be integrated into the designs of arrays 640 and 642 for this purpose. Even where a reduced number of mirrors is not utilized in arrays 640 and 642, certain construction advantages may be achieved by combining the mirrors in single arrays rather than providing arrays corresponding to the number of input fiber arrays or output fiber arrays.

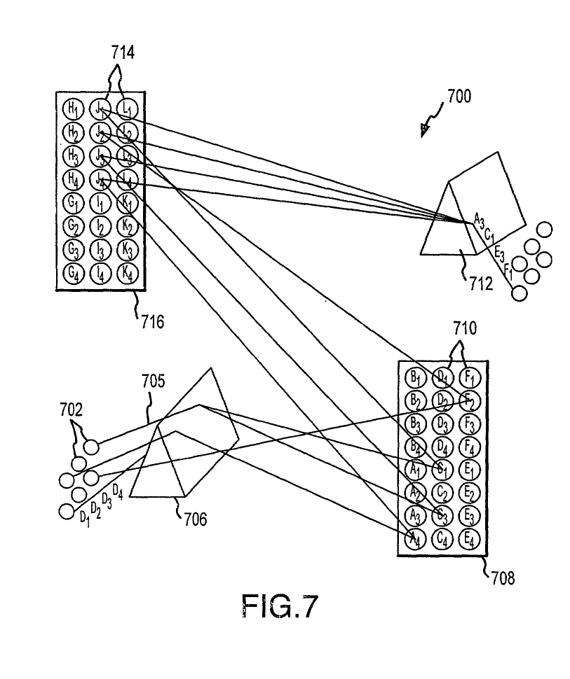

FIG. 7 illustrates an L×M×N free space optical switch with reduced components in accordance with the present invention. The switch 700 is operative for interfacing any of various multichannel input ports 702 with any of various multichannel output ports 704. In the illustrated embodiment, the switch 700 includes a two-dimensional array of input ports 702 and a two-dimensional array of output ports 704, each operative for transmitting and receiving four channel signals. For purposes of the illustration, each of the input ports is identified by a letter A-F and each of the output ports is identified by a letter G-L. Each of the channel components is identified by its port of origin and a channel number. Thus, as shown, input port D transmits a multichannel signal including components D1, D2, D3 and D4. The input signal 705 from each of the ports 702 of the two-dimensional input port array is transmitted via a single spectral device 706 to the input movable mirror array 708. Each mirror 710 of the input array 708 corresponds to a particular port and channel, as identified in the figure. Similarly, each signal transmitted by an output port 704 is transmitted via spectral device 712 to mirrors (714) of the output array 716. As shown, each mirror 714 of array 716 corresponds to a particular output port and channel. Thus, a channel component from a particular input port 702 is reflected by the corresponding mirror 710 of array 708 to the mirror 714 of array 716 associated with the corresponding channel of the desired output port 704. The process is reversed for channel components transmitted from an output port 704 to an input port 702.

It will thus be appreciated that the two arrays 708 and 716 support full multichannel switching functionality for more than two channels. Although four channels are shown in the illustrated embodiment, it will be appreciated that more than four channels could be supported. It will also be observed that a single input array 708 and a single output array 716 supports a two-dimensional array of input ports 702 and a two-dimensional array of output ports 704. Thus, the arrays 708 and 716 have dimensions related to the number of channels and the number of ports but the rows and columns of the arrays 708 and 716 need not be dedicated to individual ports or channels.

The ports and spectral devices may be configured such that, for each of the mirror arrays, one dimension corresponds to the various ports and the other dimension (in the case of planar configurations) corresponds to the various channels. Thus, for example, a given row of mirrors may correspond to the same channel for each of the associated ports and a given column of mirrors may correspond to the various channels of a given port. Because a given mirror associated with a given channel will generally route a beam to other mirrors associated with the same channel, for many applications, such a unit can be implemented using mirrors that tilt with only one degree of freedom. For example, the ports may be linearly arranged, the mirror arrays may be in a planar configuration of rows and columns and the mirrors may pivot about a single axis to couple a single channel of an input port to any of the output ports.

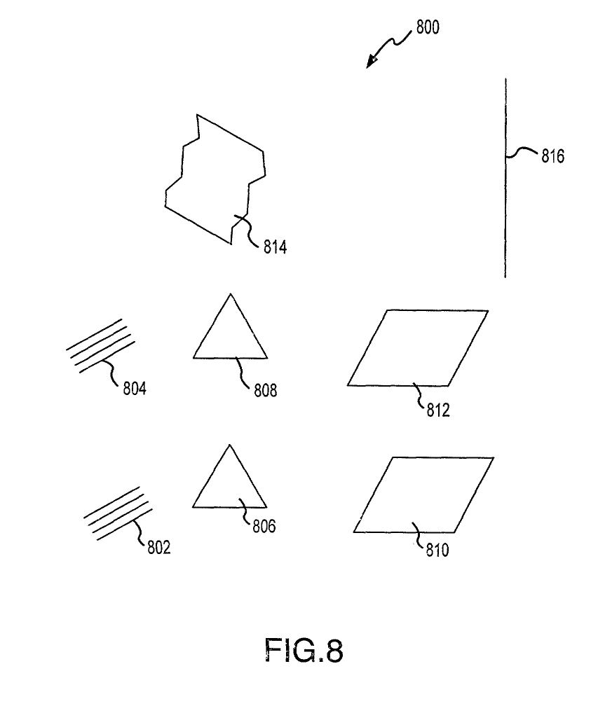

FIG. 8 illustrates a multichannel optical cross connect switch employing a folding mirror. In the illustrated switch 800, input ports 802 are interfaced with output ports 804 via spectral devices 806 and 808, an array of movable input mirrors 810, a second array of movable mirrors 814, a fixed folding mirror 816 and an array of movable output mirrors 812. In particular, a multichannel signal transmitted by one of the input ports 802 is separated into its channel components by spectral device 806. The channel components are then redirected by mirrors of array 810 to mirrors of array 814. The channel signals are then directed by mirrors of array 814 to (generally) other mirrors of array 814 via the fixed mirror 816. Finally, the channel signals are directed from the array 814 to the spectral device 808 via output array 812. The spectral device 808 combines channel signals and transmits a multichannel signal to a desired one of the output ports 804. It will be appreciated that the switch 800 may be used to connect one port of array 802 to another port of array 802, to connect one port of array 802 to a port of array 804 and/or to connect one port of array 804 to another port of array 804. The folded configuration of FIG. 8 may be desired for certain applications where the dimensions of the free space box are limited.

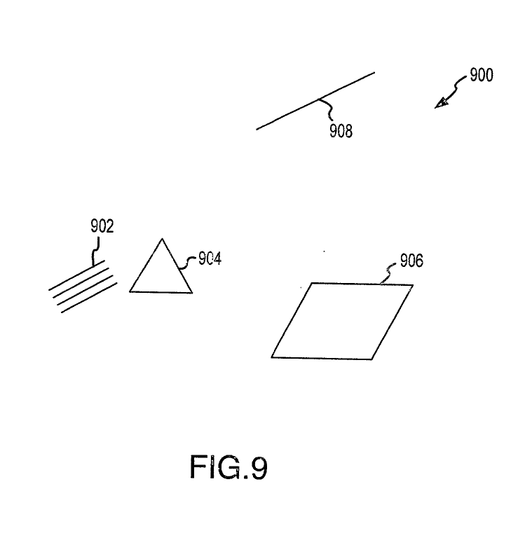

FIG. 9 shows an alternative folded optical switch implementation. The illustrated switch 900 includes a number of ports 902, a spectral device 904, an array of movable mirrors 906 and a fixed folding mirror 908. Any one of the ports 902 may be connected to another one of the ports 902 via the spectral device 904 and the mirrors 906 and 908. In particular, a multichannel signal transmitted from one of the ports 902 is separated into its channel components by spectral device 904 and the resulting channel components are transmitted to associated movable mirrors of array 906. Each of the mirrors of array 906 that receives a channel component is positioned to target (generally) another mirror of array 906 via reflection off of folding mirror 908. The targeted mirror of array 906, which may be selected based on channel as well as the desired output port, is positioned to direct the channel signal to the desired port 902 via the spectral device 904. Accordingly, the illustrated switch 900 supports a fully functional L×M×N free space switch using only one array 906 of movable mirrors. Again, the ports 902 and spectral device 904 may be configured such that the mirrors need only move with one degree of freedom (e.g., to target a linear array of mirrors) if desired.

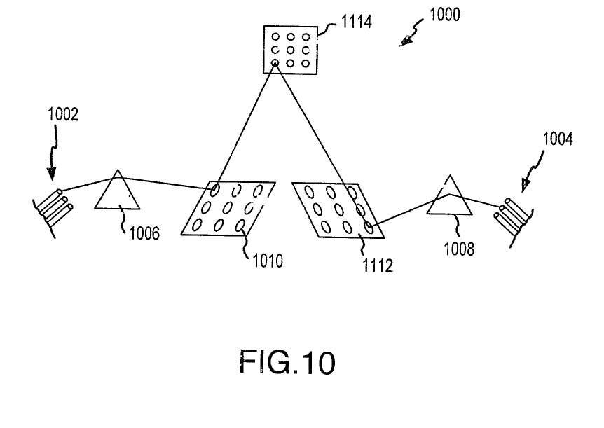

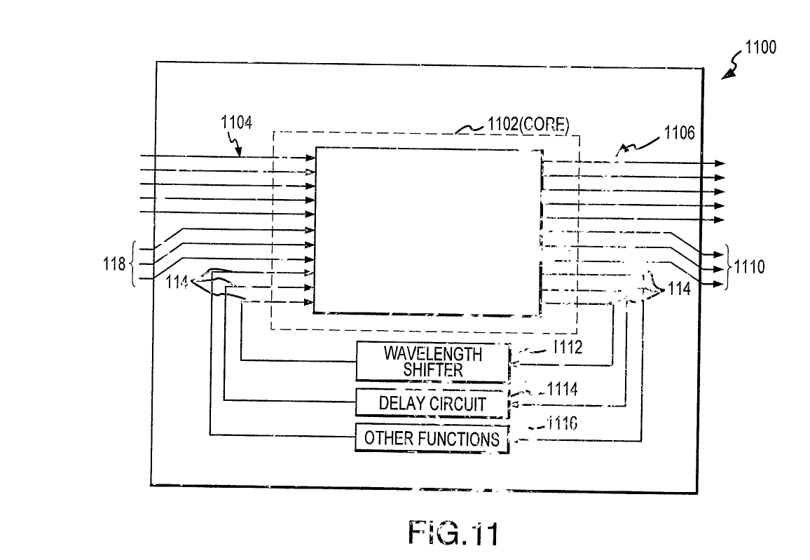

FIG. 10 illustrates yet another embodiment of an L×M×N free space switch 1000 in accordance with the present invention. The switch 1000 interfaces any of input ports 1002 with any of output ports 1004. In this regard, a multichannel signal transmitted from an input port 1002 is separated into its channel components by spectral device 1006 and the channel components are directed to associated mirrors of input array 1010. The mirrors of input array 1010 are positioned to direct the signal to a mirror of output array 1012 that is selected based on channel and the desired output port 1004. The process is reversed for signals transmitted from an output 1004 to an input port 1002. Signals are transmitted between the mirror arrays 1010 and 1012 via a folding device 1014. The folding device 1014 may be one or more fixed mirrors or movable mirrors. Although a single fixed mirror could be utilized, multiple fixed mirrors may be desired in order to achieve a desired reflection geometry, e.g., to reduce the required tilt angles for certain connections. Movable mirrors may be utilized in this regard to provide spare functionality in the event of a malfunctioning mirror of one of the arrays 1010 and 1012.

It will be appreciated that a variety of considerations may be involved in selecting a switch configuration for a particular application. Certain of the embodiments described above may be preferred for certain applications due to the reduced number of components as well as the reduced number of reflections required in achieving a particular connection. On the other hand, other configurations may be desired because of the spatial envelope available for a given switch interface or in order to achieve better optical symmetry resulting in increased optical density at an output port. Finally, it may be desired to include additional mirrors or mirror arrays in any of the embodiments described above. For example, a fixed mirror or array of fixed mirrors may be inserted between a set of ports and their associated movable mirror array for magnification or demagnification, i.e., to decouple the pitch of the mirror array from the pitch of the ports as described in U.S. patent application Ser. No. 09/968,412 entitled “Improved Configurations for an Optical CrossConnect Switch,” filed on Sep. 27, 2001, which is incorporated herein by reference.

FIG. 11 illustrates one embodiment of a multifunction optical channel processing unit 1100 or superswitch in accordance with the present invention. The illustrated unit 1100 includes a core 1102 which may be implemented as any one of the switch embodiments described above. In particular, the core includes a number of input fibers 1104 and a number of output fibers 1106. Each one of the fibers 1104 and 1106 can carry signals of one or more wavelengths and such signals my be transmitted across unit 1100 bi-directionally, notwithstanding the “input” and “output” designations and the arrows used for purposes of illustration. The core 1102 is operative for switching signals between the fibers 1104 and 1106 including on a wavelength dependent basis. The illustrated unit 1100 is operative for providing a number of functions in addition to switching. These functions may include, for example, adding signals, dropping signals, shifting the wavelengths of signals, delaying signals, and balancing signals. In this regard, a number of the input fibers are designated as add fibers 1108. The add fibers can be used to add signals to the network via either or both of the input ports 1104 and 1106. In this regard, each of the add fibers 1108 may carry signals of one or more wavelengths. In addition, a number of the output fibers 1106 are designated as drop fibers 1110. The drop fibers can be used to drop signals from the network from either or both of the input fibers 1104 and output fibers 1106. It will be appreciated that such add and drop functionality may be desired in order to route communications to particular network nodes. In this regard, the switching functionality may be utilized to reconfigure a network core and the add/drop functionality may be desired to add and drop signals from the network core.

The unit 1100 further includes a number of ports 1111 designated as signal processing ports. Pairs of these ports 1111 are interconnected via processing modules 1112, 1114 and 1116 to provide additional functionality. Examples of such functionality are set forth below. It will be appreciated that these may be multiple modules of any such type. Thus, module 1112 is designated as a wavelength shifter. It will be appreciated that it may sometimes be desired to shift the wavelengths of a signal, for example, to avoid multiplexing two signals having the same wavelengths. Thus, in such a case, at least one of the potentially conflicting signals may be shifted to a wavelength that is not already being utilized at the desired output port. The shifter 1112 may be embodied as a detector for detecting the received optical signal coupled with an optical source of the desired wavelength or turnable to a desired wavelength for reproducing the received signal at the target wavelength.

In the illustrated embodiment, module 114 is a delay circuit. In certain cases, it may be desired to impose a delay of a selected time period for a given signal or signals at the switch interface. For example, such a delay may be desired to provide time for generating switching instructions or implementing other network management functions, or to avoid signal interference at a particular port. Many other functions may be implemented in connection with unit 1100 as generally indicated by module 1116. For example, signals or signal components may be selectively amplified for channel balancing or the like. Also, such modules and associated loops may be used to dynamically reconfigure the switch to accommodate changes in the input signals and changes in the required system function. Reconfiguration also permits dynamic redundancy in the event that certain components experience a failure and permits state of health assessment of various components when unused channels are available. Module 1116 may also be operative to change one or both of the signal polarization and signal wavefront shape as may be desired. Many other such functions will be apparent to those skilled in the art.

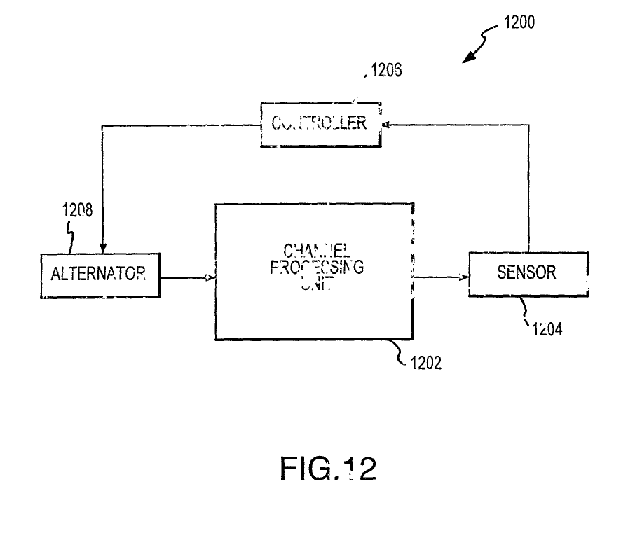

For many applications, it may be desired to balance the channel components of a WDM signal. That is, it may be desired to manage the relative strengths of the various channel components to achieve a desired relationship. In this regard, it is often desired to balance the channel components such that the components have substantially equal strengths. This may be important in WDM networks such that the various components can be handled within the preferred dynamic ranges of various network components. FIGS. 12-16 illustrate various implementations of channel balancing systems in this regard.

Referring first to FIG. 12, a channel balancing system is generally indicated by the reference numeral 1200. The balancing system 1200 is implemented in connection with a channel processing unit 1202 which may be, for example, a multiplexer or multichannel switch as described in the various embodiments above. In such embodiments, at least one port is capable of receiving a WDM signal and the illustrated system 1200 is utilized to balance the channels of this signal. In the case of a multichannel switch, such balancing may be implemented in connection with each of the input and output ports or in connection with selected ports as desired.

The illustrated system includes a sensor 1204, a controller 1206 and an attenuator 1208. The sensor 1204 is used to sense the strength of one or more channels of the WDM signal. Preferably, the sensor 1204 provides an indication of the strengths or relative strengths of each of the channel components of the WDM signal. The sensor 1204 is generally operative for receiving at least a portion of a channel component or information indicative thereof and providing a representative electronic output. The sensor 1204 may be implemented in various ways and at various locations in connection with the unit 1202 as will be discussed in more detail below.

The output from the sensor 1204 is provided to a controller 1206. The controller 1206 is operative to analyze the sensor output so as to identify an imbalance in the channel components and generate appropriate instructions for operating the attenuator 1208 to correct such imbalance. Thus, for example, the sensor output may indicate that one channel component of the WDM signal, say, channel A, is substantially stronger than another component of the WDM signal, say, channel B. The controller 1206 thus identifies this imbalance and provides an output to attenuator 1208 to implement an appropriate attenuation of channel A so that the desired balance is achieved. The controller 1206 may be embodied as a computing unit including an appropriate input port for receiving the sensor signal, a processor executing software for analyzing the sensor input and determining any appropriate corrective attenuation, and an appropriate output port for providing instructions to the attenuator 1208. The attenuator 1208 may be embodied in various kinds of attenuation systems as will be described in more detail below.

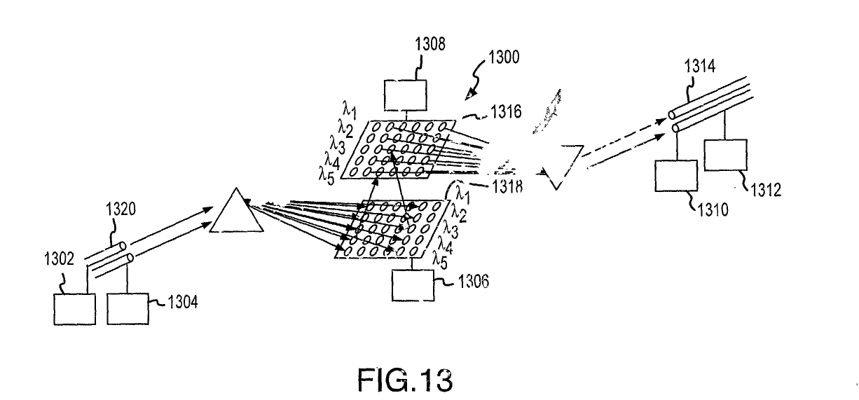

FIG. 13 is a schematic diagram of a multiwavelength optical switch 1300 as described above showing various possible sensor implementations. As discussed above, a balancing system preferably includes a sensor system for measuring the strengths or relative strengths of the various channel components of a WDM signal. This may be accomplished within the switch interface or outside of the switch interface. Thus, a sensor system may be associated with an input and/or output fiber such as indicated by modules 1302 and 1312. In this regard, various sensors are known for sensing a signal transmitted within a fiber. For example, such sensors may be implemented by providing a detector in connection with a bend in a fiber that is sufficiently sharp to allow a portion of the transmitted signal to escape the fiber at the bend. Other sensor systems can sense signals transmitted within a fiber based on certain boundary effects at the boundary of the fiber core.

Alternatively, sensor systems may be implemented in connection with the fiber ends as indicated at 1304 and 1310 or elsewhere along the signal pathways between the fiber ends. In this regard, due to practical constraints of optical systems, some portion of the transmitted optical signals may not impinge upon the fiber ends but, rather, can be detected by sensors disposed adjacent to the fiber ends, for example, on a frame supporting the fiber ends. One or more such sensor surfaces may be provided in connection with each of the fiber ends to provide an indication of the strengths or relative strengths of the various components of a WDM signal.

As a further alternative, a sensor system may be implemented in connection with one or more of the mirror arrays as indicated by modules 1306 and 1308. In this regard, detector surfaces may be interspersed with the mirrors on the array to function analogous to modules 1304 and 1310 described above. Alternatively, sensors may be provided behind the mirrors of the array. In this regard, various practical mirror implementations reflect most of the incident signals but allow transmission of a certain portion of these signals. These transmitted signal portions may be detected to provide an indication of the strengths or relative strengths of the various components of the incident WDM signals. In this regard, in the various embodiments described above, each of the mirrors of an array is generally mapped to a particular wavelength and a particular fiber. By comparing the outputs from detectors associated with such mirrors, the strengths or relative strengths of the various components of the WDM signal can be readily identified. Although various sensor implementations and locations have thus been described, other sensor implementations and positions will be apparent to those skilled in the art.

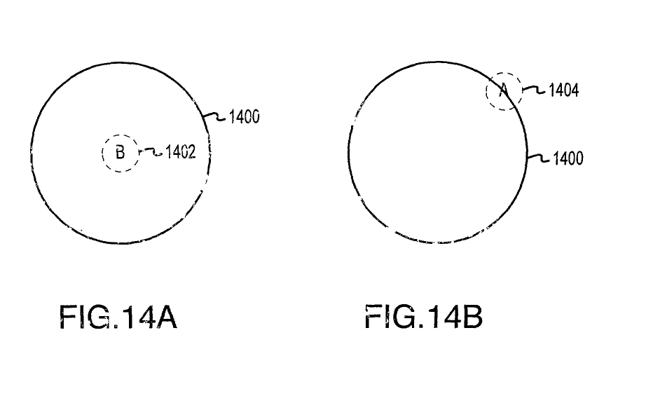

FIGS. 14A-16 illustrate various attenuation implementations. Referring first to FIGS. 14A and 14B, one way that selected components of a WDM signal can be attenuated is by selectively misaligning the associated signal transmission path. Thus, FIGS. 14A and 14B illustrate a fiber end 1400 receiving a WDM signal including two channels, A and B. For the purposes of these illustrations, it is assumed that it has been determined that component A was stronger than component B and an attenuation process has been implemented to attenuate signal A. The associated attenuation process is implemented by controlling the position of one or more mirrors to slightly misalign signal component A. Thus, in FIG. 14A, the optical footprint of the channel B signal is indicated at 1402. As shown, the path of this signal is properly aligned (e.g., centered) relative to fiber end 1400 such that substantially the full signal is received within the fiber core. By contrast, as shown in FIG. 14B, the optical footprint 1404 of signal component A is slightly misaligned (e.g., off-center) relative to fiber end 1400 so that (in the illustrated case) only a portion of the signal is received within the fiber core. Thus, attenuation of component A is achieved by selective misalignment of its optical path relative to the fiber end 1400.

Such attenuation through selective misalignment may be implemented in a variety of ways. For example, such attenuation may be implemented by operating one or more of the mirrors to slightly “mistarget” a fiber or other port as shown. Alternatively, a mirror in a series of mirrors between the ports may be operated to selectively mistarget a subsequent mirror or other optical component between the parts.

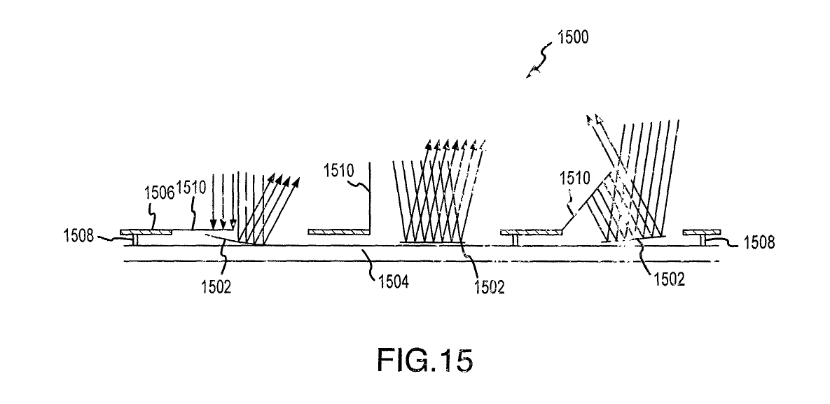

Alternatively, such attenuation can be achieved by selectively blocking a portion of the signal associated with the component to be attenuated. FIG. 15 shows such a system 1500. The system 1500 generally includes an array of movable mirrors 1502 formed on a substrate 1504. For example, the array of mirrors may be implemented as described in the various embodiments where individual mirrors are mapped to individual wavelengths of individual fibers. In the illustrated embodiments, a shutter layer 1506 is interconnected to the substrate 1504 by alignment posts 1508. The shutter layer 1506 includes a number of deployable shutters 1510 and associated actuator components as generally described in U.S. patent application Ser. No. [not yet assigned] entitled “Alignment Tolerant Architectures for Optical Signal Control Systems” filed concurrently herewith and incorporated herein by reference. In this regard, the shutters 1510 may be silicon structures that can be selectively rotated into the path of beams transmitted to or from the mirrors so as to block a portion thereof. In this manner, the shutters can be individually operated to selectively attenuate the various components of a WDM signal.

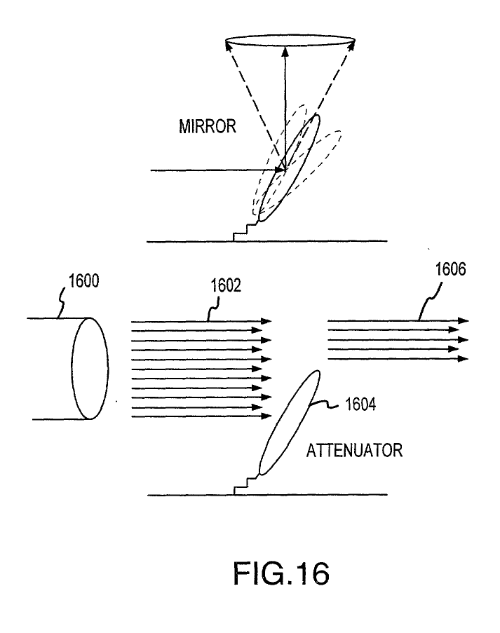

FIG. 16 illustrates an alternative implementation of an attenuation system. The attenuation system comprises a deployable silicon or other structure 1604 formed on a substrate 1608. The structure 1604 can be positioned by a large tilt angle actuator as generally described in U.S. patent Ser. No. 09/966,963 entitled “Large Tilt Angle MEM Platform” noted above. As shown, the structure 1604 can be selectively extended into a path of a signal 1602 transmitted from a fiber 1600 so as to provide an attenuated signal 1606.

While various embodiments of the present invention have been described in detail, it is apparent that further modifications and adaptations of the invention will occur to those skilled in the art. However, it is to be expressly understood that such modifications and adaptations are within the spirit and scope of the present invention.

What is claimed:

1. An optical apparatus for use in a communications network that utilizes multiple channels associated with multiple wavelengths, comprising:
at least one first optical port;
a plurality of second optical ports;
a first array of mirrors disposed on a common support surface;
the first array of mirrors being optically interposed between the at least one first port and the plurality of second optical ports for redirecting optical signals transmitted therebetween;
a first spectral processing device disposed between said at least one first port and said second ports, operative for one of:
a) combining at least two signals of different channels into a single multichannel signal, and
b) separating a single multichannel signal into at least two signals of different channels;
said first array being operative for receiving and redirecting at least a first signal of a first channel and a second signal of a second channel.

2. An optical apparatus as set forth in claim 1, wherein the first port comprises an optical fiber.

3. An optical apparatus as set forth in claim 1, Wherein at least one of the second ports comprises an optical fiber.

4. An optical apparatus as set forth in claim 1, wherein said first optical port is an input port for transmitting a multichannel signal to said first array via said spectral processing device.

5. An optical apparatus as set forth in claim 1, wherein said first port is an output port for receiving a multichannel signal.

6. An optical apparatus as set forth in claim 1, wherein said at least one first port comprises a plurality of first ports.

7. An optical apparatus as set forth in claim 6, wherein said spectral processing device and said first array are useful for processing a first multichannel signal from a first one of said first ports and a second multichannel signal from a second one of said first ports so as to provide a third multichannel signal at one of said second ports, where said third multichannel signal includes a first channel component corresponding to a channel component of said first multichannel signal and a second channel component corresponding to a channel component of said second multichannel signal.

8. An optical apparatus as set forth in claim 1, wherein said mirrors of said first array are arranged in a substantially planar configuration.

9. An optical apparatus as set forth in claim 1, wherein at least two of said mirrors of said first array comprise MEMS devices formed on a common substrate.

10. An optical apparatus as set forth in claim 1, wherein said first array includes a first dimension related to a number of said first ports and a second dimension related to a number of channels associated with said first ports.

11. An optical apparatus as set forth in claim 1, further comprising a second array of mirrors optically interposed between said plurality of second optical ports and the first array of mirrors for redirecting optical beams transmitted therebetween.

12. An optical apparatus as set forth in claim 11, wherein said optical apparatus includes a number of mirror arrays, M, including said first and second arrays and is operative for switching signals of multiple channels, N, where N is greater than M.

13. An optical apparatus as set forth in claim 11, wherein said second array receives signals from said first array and transmits signals to said first array.

14. An optical apparatus as set forth in claim 11, wherein said at least one first port comprises a plurality of first ports and said apparatus further comprises:
a second spectral processing device disposed between said second array of mirrors and said plurality of second ports, wherein each of said first and second spectral processing devices is operative for both:
a) combining at least two signals of different channels into a single multichannel signal, and
b) separating a single multichannel signal into at least two signals of different channels.

15. An optical apparatus as set forth in claim 11, further comprising at least one additional mirror, wherein an optical signal is transmitted between said first port and one of said second ports via a first mirror of said first array, a second mirror of said second array and said additional mirror.

16. An optical apparatus as set forth in claim 11, further comprising a third array of mirrors.

17. An optical apparatus as set forth in claim 16, wherein said third array of mirrors is disposed in optical series with said first and second arrays such that an optical signal transmitted between said first port and one of said second ports is redirected via each of said first, second and third arrays.

18. An optical apparatus as set forth in claim 16, wherein said first, second and third arrays define parallel pathways between said first and second ports such that an optical signal transmitted between said first and second ports is redirected via no more than two of said first, second and third arrays.

19. An optical apparatus as set forth in claim 1, further comprising a mirror for reflecting an optical signal between a first mirror of said first array and a second mirror of said first array.

20. An optical apparatus as set forth in claim 1, further comprising an additional port operative for one of adding an optical signal and dropping an optical signal via one of said first and second ports.

21. An optical apparatus as set forth in claim 1, further comprising first and second additional ports optically associated with said first array of mirrors and a signal processor disposed between said first additional port and said second additional port.

22. An optical apparatus as set forth in claim 1, further comprising a channel balancer for balancing channel components of a multi-channel signal.

23. An optical apparatus for use in a communications network that utilizes multiple channels associated with multiple wavelengths, comprising:
at least one first port;
a plurality of second ports;
a first spectral processing device for implementing a channel management operation relative to a multichannel signal having N channels, said channel management operation comprising one of:
a) combining at least two signals of different channels into a single multichannel signal, and
b) separating a single multichannel signal into at least two signals of different channels; and
a signal redirecting system optically interposed between said spectral processing device and said plurality of second ports for redirecting signals transmitted therebetween, wherein said signal redirecting system includes a number of mirror arrays, M, each said mirror array comprising a number of mirrors mounted on a common support structure, where each of M and N are integers and N is greater than M.

24. An optical apparatus as set forth in claim23, wherein the first port comprises an optical fiber.

25. An optical apparatus as set forth in claim 23, wherein at least one of the second ports comprises an optical fiber.

26. An optical apparatus as set forth in claim 23, wherein said first optical port is an input port for transmitting a multichannel signal to said spectral processing device.

27. An optical apparatus as set forth in claim 23, wherein said first port is an output port for receiving a multichannel signal.

28. An optical apparatus as set forth in claim 23, wherein said at least one first port comprises a plurality of first ports.

29. An optical apparatus as set forth in claim 28, wherein said spectral processing device and said first array are useful for processing a first multichannel signal from a first one of said first ports and a second multichannel signal from a second one of said first ports so as to provide a third multichannel signal at one of said second ports, where said third multichannel signal includes a first channel component corresponding to a channel component of said first multichannel signal and a second channel component corresponding to a channel component of said second multichannel signal.

30. An optical apparatus as set forth in claim 23, wherein said mirrors of said first array are arranged in a substantially planar configuration.

31. An optical apparatus as set forth in claim 23, wherein at least two of said mirrors of said first array are formed as MEMS devices on a common substrate.

32. An optical apparatus as set forth in claim 23, wherein said first array includes a first dimension related to a number of said first ports and a second dimension related to a number of channels associated with said first ports.

33. An optical apparatus as set forth in claim 23, further comprising a second spectral processing device.

34. An optical apparatus as set forth in claim 23, further comprising at least one additional mirror, where an optical signal is transmitted between said first port and one of said second ports via a first mirror of one of said arrays, a second mirror of the same or another one of said arrays and said additional mirror.

35. An optical apparatus as set forth in claim 23, wherein M is greater than 1.

36. An optical apparatus as set forth in claim 23, further comprising an additional port operative for one of adding an optical signal and dropping an optical signal via one of said first and second ports.

37. An optical apparatus as set forth in claim 23, further comprising first and second additional ports optically associated with said first array of mirrors and a signal processor disposed between said first additional port and said second additional port.

38. An optical apparatus as set forth in claim 23, further comprising a channel balancer for balancing channel components of a multi-channel signal.

39. An optical apparatus for use in a communications network that utilizes multiple channels associated with multiple wavelengths, comprising:
at least one first port for transmitting an input signal having multiple channel components into a free space interface;
a plurality of second ports for receiving output signals from said free space interface;
a spectral processing device disposed in said free space interface between said at least one first port and said plurality of second ports for receiving said input signal and separating said input signal into at least two channel components; and
a signal redirecting system optically interposed between said at least one first port and said second ports for redirecting signals transmitted therebetween, said signal redirecting system including a first array of movable mirrors disposed on a common support surface, wherein said first array is operative to redirect at least a first signal component of a first channel and a second signal component of a second channel.

40. An optical apparatus as set forth in claim 39, wherein said at least one first port comprises a plurality of first ports.

41. An optical apparatus as set forth in claim 39, wherein said mirrors of said first array are arranged in a substantially planar configuration.

42. An optical apparatus as set forth in claim 39, wherein said mirrors of said first array are formed on a common substrate.

43. An optical apparatus as set forth in claim 39, wherein said first array includes a first dimension related to a number of said first ports and a second dimension related to a number of channels associated with said first ports.

44. An optical apparatus as set forth in claim 39, further comprising a second array of mirrors optically interposed between said plurality of second optical ports and the first array of mirrors for redirecting optical beams transmitted therebetween.

45. An optical apparatus for use in a communications network that utilizes multiple channels associated with multiple wavelengths comprising:
an array of first ports for transmitting multiple input signals into a free space interface, each of said input signals having at least one channel component;
at least one second port for receiving at least one output signal from said free space interface;
a spectral processing device disposed in said free space signal processing interface between said at least one second port and said array of first ports for receiving said input signals and combining at least two of said input signals into a multichannel output signal; and
a signal redirecting system optically interposed between said at least one second port and said first ports for redirecting signals transmitted therebetween, said signal redirecting system including a first array of movable mirrors disposed on a common support surface, wherein said first array is operative to redirect at least a first signal component of a first channel and a second signal component of a second channel.

46. An optical apparatus as set forth in claim 45, wherein said at least one second port comprises a plurality of second ports.

47. An optical apparatus as set forth in claim 45, wherein said mirrors of said first array are arranged in a substantially planar configuration.

48. An optical apparatus as set forth in claim 45, wherein said mirrors of said first array are formed on a common substrate.

49. An optical apparatus as set forth in claim 45, wherein said first array includes a first dimension related to a number of said first ports and a second dimension related to a number of channels associated with said first ports.

50. An optical apparatus as set forth in claim 45, further comprising a second array of mirrors optically interposed between said at least one second optical port and the first array of mirrors for redirecting optical beams transmitted therebetween.

51. An optical apparatus for use in a communications network that utilizes multiple channels associated with multiple wavelengths, comprising:
a first array of optical ports;
a second array of optical ports;
a first array of mirrors;
a second array of mirrors;
first and second spectral processing devices operative for both of:
a) combining at least two signals of different channels into a single multichannel signal, and
b) separating a single multichannel signal into at least two signals of different channels;
said first spectral processing device being disposed between said first array of ports and said first array of mirrors;
said second spectral processing device being disposed between said second array of mirrors and said second array of ports;
wherein said optical apparatus is configurable such that at least one of the first and second mirror arrays is operative for receiving and redirecting at least a first signal of a first channel and a second signal of a second channel.

52. An optical apparatus as set forth in claim 51, wherein said optical apparatus includes a number of mirror arrays, M, including said first and second arrays and is operative for switching signals of multiple channels, N, where N is greater than M.

53. An optical apparatus as set forth in claim 51, further comprising at least one additional mirror, wherein an optical signal is transmitted between said first port and one of said second ports via a first mirror of said first array, a second mirror of said second array and said additional mirror.

54. An optical apparatus as set forth in claim 51, further comprising a third array of mirrors.

55. An optical apparatus as set forth in claim 51, wherein said third array of mirrors is disposed in optical series with said first and second arrays such that an optical signal transmitted between said first port and one of said second ports is redirected via each of said first, second and third arrays.

56. An optical apparatus as set forth in claim 51, wherein said first, second and third arrays define parallel pathways between said first and second ports such that an optical signal transmitted between said first and second ports is redirected via no more than two of said first, second and third arrays.

57. An apparatus as set forth in claim 51, wherein at least some of said mirrors of said first and second arrays are movable with more than one degree of freedom.

58. An apparatus as set forth in claim 51, wherein each of said mirrors of said first and second arrays is movable with only one degree of freedom.

59. A method for use in a communications network that utilizes multiple channels associated with multiple wavelengths, comprising the steps of:
providing a first array of movable mirrors disposed on a common support surface where each of said mirrors is operative for redirecting optical signals transmitted between an input port and an output port;
providing a channel processor between said input port and output ports wherein said channel processor directs optical signals on a wavelength dependent basis;
operating a first one of said mirrors to redirect a first signal having a first channel composition; and
operating a second one of said mirrors to redirect a signal having a second channel composition.

60. A method as set forth in claim 59, wherein each of said first and second signals is a single channel signal.

61. A method as set forth in claim 59, further comprising the step of separating a multichannel signal from a given input port into multiple single channel signals.

62. A method as set forth in claim 59, further comprising the step of combining multiple single channel signals into a single multichannel signal and directing and said multichannel signal to a given output port.

63. A method as set forth in claim 59, further comprising the steps of:
providing an additional mirror; and
routing at least a signal component between a given input port and a given output port via one of said mirrors of said first array and said additional mirror.

64. A method as set forth in claim 59, wherein said step of routing comprises operating said additional mirror to redirect said signal component from one mirror of said first array to another mirror of said first array.

65. A method as set forth in claim 59, wherein said step of providing an additional mirror comprises providing a second array of movable mirrors.
